(19) United States
(12) Patent Application Publication
(10) Pub. No.: US 2014/0317056 A1
(43) Pub. Date: Oct. 23, 2014

(54) METHOD OF DISTRIBUTING AND STORING FILE-BASED DATA

(71) Applicant: Electronics and Telecommunications Research Institute, Daejeon (KR)

(72) Inventors: Youngchul KIM, Daejeon (KR); Hong Yeon KIM, Daejeon (KR); Young Kyun KIM, Daejeon (KR)

(73) Assignee: Electronics and Telecommunications Research Institute, Daejeon (KR)

(21) Appl. No.: 13/950,800

(22) Filed: Jul. 25, 2013

(30) Foreign Application Priority Data
Apr. 17, 2013 (KR) 10-2013-0042501

(51) Int. Cl. G06F 17/30

(52) U.S. Cl. CPC G06F 17/30581
USPC 707/634

(57) ABSTRACT

A metadata server of a distributed file system calculates an access frequency of a file and changes a maintaining method of chunks of a data server for dividing data of the file into chunk units to store the chunks in a stripe in accordance with access frequency of the file.

### CROSS-REFERENCE TO RELATED APPLICATION

This application claims priority to and the benefit of Korean Patent Application No. 10-2013-0042501 filed in the Korean Intellectual Property Office on Apr. 17, 2013, the entire contents of which are incorporated herein by reference.

### BACKGROUND OF THE INVENTION

(a) Field of the Invention

The present invention relates to a method of distributing and storing file-based data, and more particularly, to a method of providing storage efficiency and availability in distributing and storing file-based data in data servers connected by a network in a distributed file system.

(b) Description of the Related Art

A distributed file system separates metadata and actual data of a file from each other to store and manage the separated metadata and actual data.

In general, the metadata describes other data and may be referred to as attribute data.

The metadata is managed by a metadata server. The actual data is distributed and stored in a plurality of data servers.

The metadata includes information on the data servers in which the actual data is stored. The metadata server and the plurality of data servers are connected by a network to be distributed.

Therefore, channels through which a client accesses the metadata and the actual data of the file are separated. That is, in order to access the file, the client first accesses the metadata of the file in the metadata server to obtain information on the plurality of data servers in which the actual data is stored. The actual data is input and output through the plurality of data servers.

The actual data of the file is divided into data units to have a predetermined size and stored in the data servers connected by the network. Each divided and stored data unit is referred to as a chunk, and chunks stored in a data server are copied to be stored in another data server in case the data server malfunctions. When it is sensed that the data server has malfunctioned, a predetermined number of copies of primary chunks stored in the data server that has malfunctioned must be maintained. If the number of copies of primary chunks is not maintained, when the data server continuously malfunctions, access to the primary chunks may not be performed. The number of copies may be determined by importance or access frequency of data. In order to store the actual data, an occupied storage space may be doubled in accordance with the number of copies.

However, in a method of replicating and maintaining data in case a data server malfunctions, data or copies of which access frequency is low are maintained so that storage space is wasted. On the other hand, copies are distributed and stored in a number of data servers so that an access load of a client may be distributed.

Therefore, a method of distributing, storing, and maintaining data in accordance with access frequency, efficiently using storage, and providing services in a state where a data server has malfunctioned is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

A technical object of the present invention is to provide a method of distributing and storing file-based data that is capable of distributing, storing, and maintaining data in accordance with an access frequency, efficiently using storage, and providing services even in a state where a data server has malfunctioned.

According to an exemplary embodiment of the present invention, a method of a metadata server of a distributed file system distributing and storing data of a file is provided. The method of distributing and storing data includes calculating an access frequency of the file, and changing a maintaining method of chunks of a data server for dividing data of the file into chunk units to store the chunks in a stripe in accordance with the access frequency of the file.

The changing a maintaining method of chunks includes determining the maintaining method as a replication method when the access frequency of the file is no less than a predetermined value, and determining the maintaining method as a parity method when the access frequency of the file is less than a predetermined value.

Determining the maintaining method as a replication method includes allocating replica chunks of primary chunks of the file to a first data server of a plurality of data servers, and requesting the first data server to replicate the replica chunks.

Determining the maintaining method as the replication method further includes changing a layout of the file when the replication is completed.

Determining the maintaining method as the replication method further includes the first data server converting a stripe having primary chunks and parity chunks in a parity method into a stripe having primary chunks and replica chunks in the replication method.

Allocating replica chunks of primary chunks of the file to the first data server includes selecting a different data server from a data server in which the other replica chunks of the primary chunks are stored in the plurality of data servers as the first data server.

Determining the maintaining method as the parity method includes allocating parity chunks in a stripe to the first data server of a plurality of data servers, and requesting the first data server to perform parity encoding on the stripe.

Determining the maintaining method as the parity method further includes changing a layout of the file when the parity encoding is successfully completed.

Determining the maintaining method as the parity method further includes the first data server converting a stripe having primary chunks and replica chunks into a stripe having primary chunks and parity chunks.

Allocating parity chunks in a stripe to the first data server includes selecting a different data server from a data server in which primary chunks and parity chunks that belong to the same stripe are stored in the plurality of data servers as the first data server.

The method further includes allocating the chunk to the data server in accordance with a type of the chunk.

Allocating parity chunks in a stripe to the first data server includes allocating the chunk to a different data server from a data server to which other primary chunks that form the file are allocated in a plurality of data servers when a type of the chunk is a primary chunk stored in a replication method, and allocating the chunk to a different data server from a data server in which the other primary chunks and parity chunks that belong to the same stripe are stored in the plurality of data servers when a type of the chunk is a primary chunk stored in the parity method.

The method further includes deleting chunks stored in the data server in accordance with a type of the chunk.

Deleting chunks stored in the data server includes, when a chunk to be deleted is a primary chunk, a replica chunk, or a parity chunk stored in a replication method, deleting the corresponding chunk, and when a chunk to be deleted is a primary chunk stored in a parity method, generating parity chunks to allocate the generated parity chunks to the same stripe and deleting the corresponding chunk.

Changing a maintaining method of chunks further includes determining the maintaining method as a replication method when data of a file stored in the parity method is updated.

The method further includes allocating chunks of a data server that has malfunctioned to the first data server of a plurality of data servers to request the first data server to recover the allocated chunks.

According to another exemplary embodiment of the present invention, a method of a data server of a distributed file system distributing and storing data of a file is provided. The method includes dividing data of the file into chunk units to store the chunks in a stripe, receiving a request to change a method of maintaining chunks of the file from a metadata server, and changing a method of maintaining chunks of the file. The metadata server determines whether to change a method of maintaining chunks of the file in accordance with an access frequency of the file.

Changing a method of maintaining chunks of the file includes changing the method to a replication method when an access frequency of the file is no less than a predetermined value, and changing the method into a parity method when an access frequency of the file is less than the predetermined value.

Changing a method of maintaining chunks of the file further includes changing the method to a replication method when data of a file stored in the parity method is updated.

The method further includes, when a primary chunk in a replication method is inaccessible, replicating replications of the other replica chunks of the primary chunk that is inaccessible to replica chunks allocated by the metadata server, when a parity chunk is inaccessible, reading primary chunks of the corresponding stripe using parity chunks allocated by the metadata server to recover the read primary chunks, and, when a primary chunk in a parity method inaccessible, reading the other primary chunks and parity chunks of the corresponding stripe using primary chunks allocated by the metadata server to recover the inaccessible primary chunk.

### BRIEF DESCRIPTION OF THE DRAWINGS

FIG. 1 is a view illustrating a distributed file system according to an exemplary embodiment of the present invention.

FIG. 2 is a view illustrating an example of a layout of a file managed by a metadata server according to an exemplary embodiment of the present invention.

FIG. 3 is a view illustrating another example of a layout of a file managed by a metadata server according to an exemplary embodiment of the present invention.

FIG. 4 is a view illustrating still another example of a layout of a file managed by a metadata server according to an exemplary embodiment of the present invention.

FIG. 5 is a view schematically illustrating a method of a metadata server according to an exemplary embodiment of the present invention allocating chunks of a file.

FIG. 6 is a view schematically illustrating a method of a metadata server according to an exemplary embodiment of the present invention deleting chunks of a file.

FIG. 7 is a view illustrating a method of a metadata server according to an exemplary embodiment of the present invention managing chunks allocated to a data server.

FIG. 8 is a flowchart illustrating an example of a method of a metadata server according to an exemplary embodiment of the present invention converting a file stored in a replication method into that stored in a parity method.

FIG. 9 is a flowchart illustrating an example of a method of a metadata server according to an exemplary embodiment of the present invention converting a file stored in a parity method into that stored in a replication method.

FIG. 10 is a flowchart illustrating another example of a method of a metadata server according to an exemplary embodiment of the present invention converting a file stored in a parity method into that stored in a replication method.

FIG. 11 is a flowchart illustrating processes when a data server has malfunctioned in a client according to an exemplary embodiment of the present invention.

FIG. 12 is a flowchart illustrating a method of a data server according to an exemplary embodiment of the present invention recovering data.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout specification and claims, unless explicitly described to the contrary, the word “comprise” and variations such as “comprises” or “comprising” will be understood to imply the inclusion of stated elements but not the exclusion of any other elements.

A method of distributing and storing file-based data according to an exemplary embodiment of the present invention will be described in detail with reference to the accompanying drawings.

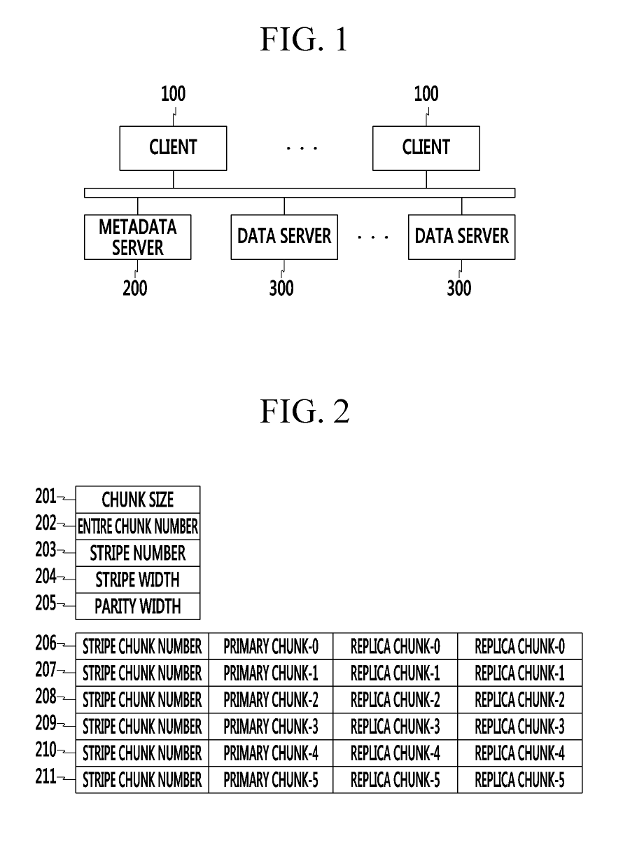

FIG. 1 is a view illustrating a distributed file system according to an exemplary embodiment of the present invention.

Referring to FIG. 1, a distributed file system includes clients 100, a metadata server 200, and a plurality of data servers 300.

The clients 100 perform client applications. The clients 100 access metadata of files stored in the metadata server 200. The clients 100 input and output data of files stored in the data servers 300.

The metadata server 200 stores and manages metadata of all of the files of the distributed file system. The metadata server 200 manages state information on all of the data servers 300. That is, the metadata describing other data includes information on a data server in which data of a file is stored.

The data servers 300 store and manage primary chunks of a file. The data servers 300 periodically report state information thereon to the metadata server 200.

The clients 100, the metadata server 200, and the plurality of data servers 300 are connected to each other by a network, and the metadata server 200 and the plurality of data servers 300 are distributed.

Data of a file is divided into data units to have a predetermined size and stored in the plurality of data servers 300 connected by the network. Each divided and stored data unit is referred to as a chunk. At this time, data of a file is striped in the plurality of data servers 300.

The chunks stored in the data server 300 are copied and stored in the other data servers 300 in case the data server 300 malfunctions. In addition, a predetermined number of copies of chunks are maintained in case the data server continuously malfunctions.

FIG. 2 is a view illustrating an example of a layout of a file managed by a metadata server according to an exemplary embodiment of the present invention, in which a layout when the data servers 300 maintain chunks of a file in a replication method is schematically illustrated.

When the data servers 300 maintain copies of chunks of a file, each stripe includes a primary chunk (primary chunk-0, primary chunk-1, primary chunk-2, primary chunk-3, primary chunk-4, and primary chunk-5) and at least one replica chunk (replica chunk-0, replica chunk-1, replica chunk-2, replica chunk-3, replica chunk-4, and replica chunk-5).

In the case of the replication method, a chunk includes a primary chunk and a replica chunk. Original data is stored in the primary chunk, and the replica chunk is created by replicating the primary chunk. An addition to a file and a change in a file is performed only on the primary chunk, and data reflected to the primary chunk is copied to the replica chunk.

When the data servers 300 maintain copies of chunks of a file, as illustrated in FIG. 2, a layout of a file maintained and managed by the metadata server 200 includes information including a chunk size 201, an entire chunk number 202, a stripe number 203, a stripe width 204, and a parity width 205 and information items 206, 207, 208, 209, 210, and 211 on a plurality of stripes.

The chunk size 201 may vary depending on the file, and all of the chunks have the same size in a file.

The entire chunk number 202 means the number of primary chunks and replica chunks that belong to a file.

The stripe number 203 may be determined by the number 202 of entire chunks that belong to a file, the stripe width 204, and the parity width 205.

The stripe width 204 means the number of primary chunks in a stripe in the replication method. Therefore, in the replication method, the stripe width is commonly 1.

The parity width 205 means the number of replica chunks in a stripe in the replication method. For example, when the parity width is 1, a replication is provided. In this case, although the data server 300 in which a chunk that belongs to the stripe is stored has malfunctioned, it is possible to cope with the failure. However, when the two data servers 300 in which two chunks that belong to the stripe are stored have malfunctioned, it is difficult to cope with the failure. Therefore, when two copies are provided, that is, when the parity width is 2, although the two data servers 300 in which the two chunks that belong to the stripe are stored are simultaneously malfunctioning, it is possible to cope with the failure.

The information items 206, 207, 208, 209, 210, and 211 on the stripes maintain the number of chunks that belong to the stripes and information on the chunks (primary chunk-0, primary chunk-1, primary chunk-2, primary chunk-3, primary chunk-4, primary chunk-5, replica chunk-0, replica chunk-1, replica chunk-2, replica chunk-3, replica chunk-4, and replica chunk-5). Information on a chunk includes a data server in which the chunk is stored, disk information, a chunk identifier, a chunk version, and state information.

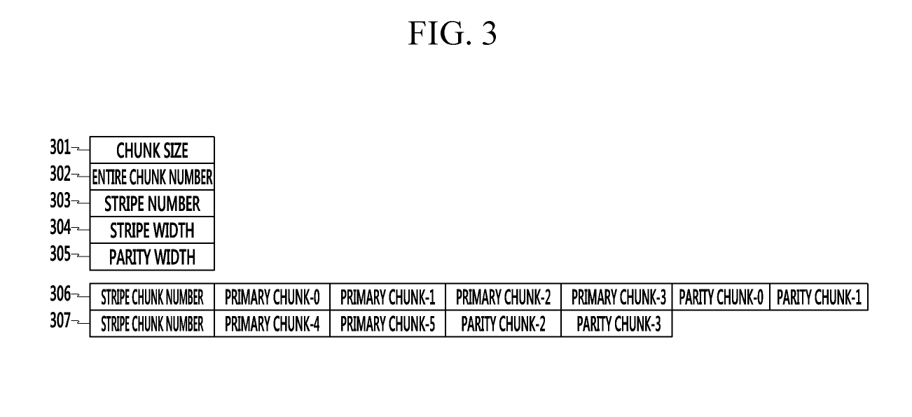

FIG. 3 is a view illustrating another example of a layout of a file managed by a metadata server according to an exemplary embodiment of the present invention, in which a layout when the data server 300 maintains chunks of a file in a parity method is schematically illustrated.

When the data server 300 maintains chunks of a file in a parity method, each stripe includes a plurality of primary chunks (primary chunk-0, primary chunk-1, primary chunk-2, primary chunk-3, primary chunk-4, and primary chunk-5) and at least one parity chunk (parity chunk-0, parity chunk-1, parity chunk-2, and parity chunk-3).

As illustrated in FIG. 3, a layout of a file maintained and managed by the metadata server 200 includes information including a chunk size 301, an entire chunk number 302, a stripe number 303, a stripe width 304, and a parity width 305 and information items 306 and 307 on a plurality of stripes, like in the replication method.

In the parity method, a chunk includes a primary chunk and a parity chunk. Actual file data is stored in the primary chunk. Parity data obtained by encoding data of the primary chunk that belongs to a stripe is encoded in a parity encoding method and is stored in the parity chunk. That is, the parity data is created by the data of the primary chunk that belongs to the stripe so that availability of data may be provided. The parity data may be generated by performing an exclusive or (XOR) function on the data of the primary chunk, or by a number of encoding methods. In this case, when the data server has malfunctioned, chunks that do not work may be recovered by performing XOR on primary chunks different from parity chunks or by a number of decoding methods. Therefore, in a distributed file system for distributing and storing file-based data, it is possible to prevent a storage space from being wasted due to copies and to provide the same availability as that provided when copies are provided.

The chunk size 301 means sizes of primary chunks and parity chunks that belong to a file.

The entire chunk number 302 means the number of primary chunks and parity chunks that belong to a file.

The stripe number 303 means the number of stripes that belong to a file, and may be determined by the entire chunk number 302, the stripe width 304, and the parity width 305.

The stripe width 304 means the number of primary chunks that belong to a stripe. In the parity method, the stripe width 304 is commonly no less than 2.

The parity width 305 means the number of parity chunks that belong to a stripe. A degree to which it is possible to cope with failure may vary with the parity width 305. When the parity width 305 is 1, the same effect may be obtained as that obtained when the parity width is 1, that is, one replication is provided in the replication method. Therefore, when the data server 300 in which a primary chunk that belongs to the stripe is stored has malfunctioned, it is possible to cope with the failure. However, when the two data servers 300 in which two primary chunks that belong to the stripe are stored simultaneously malfunction, it is difficult to cope with the failure. When the parity width 305 is 2, the same effect is obtained as that obtained when the parity width is 2, that is, two copies are provided in the replication method. Therefore, although the two data servers 300 in which the two primary chunks that belong to the stripe are stored simultaneously malfunction, it is possible to cope with the failure.

The information items 306 and 307 on the stripes include the number of chunks that belong to the stripes, and information on the primary chunks (primary chunk-0, primary chunk-1, primary chunk-2, primary chunk-3, primary chunk-4, and primary chunk-5) and the parity chunks (parity chunk-0, parity chunk-1, parity chunk-2, and parity chunk-3). Information on a chunk includes a data server in which the chunk is stored, disk information, a chunk identifier, a chunk version, and state information.

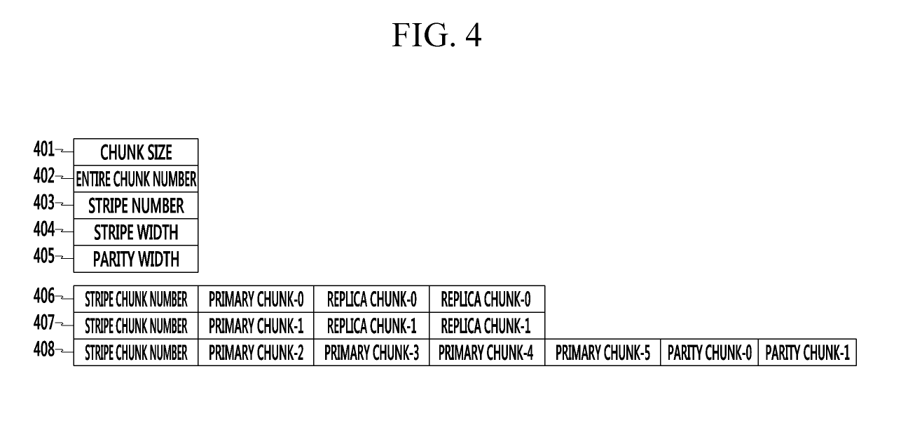

FIG. 4 is a view illustrating still another example of a layout of a file managed by a metadata server according to an exemplary embodiment of the present invention, in which a layout when the data server 300 maintains chunks of a file in a mixed method is schematically illustrated. Here, the mixed method means a method in which the replication method and the parity method are mixed with each other.

When the data server 300 maintains chunks of a file in the mixed method, each of parts of a plurality of stripes includes a primary chunk (primary chunk-0 and primary chunk-1) and at least one replica chunk (replica chunk-0 and replica chunk-1), and the remaining stripe includes a plurality of primary chunks (primary chunk-2, primary chunk-3, primary chunk-4, and primary chunk-5) and at least one parity chunk (parity chunk-0 and parity chunk-1).

When the data server 300 maintains chunks of a file in the mixed method, as illustrated in FIG. 4, a layout of a file maintained and managed by the metadata server 200 includes information including a chunk size 401, an entire chunk number 402, a stripe number 403, a stripe width 404, and a parity width 405 and information items 406, 407, and 408 on a plurality of stripes.

In the mixed method, the chunk size 401, the entire chunk number 402, the stripe number 403, the stripe width 404, and the parity width 405 are the same as those of the replication method or the parity method. In the mixed method, the stripe width 404 and the parity width 405 are maintained considering the parity method first.

The information items 406, 407, and 408 on the stripes include the number of chunks that belong to the stripes and information on the chunks, like in the replication method or the parity method. The chunks may be at least one of primary chunks, replica chunks, and parity chunks. The above may be determined by the information on the chunks.

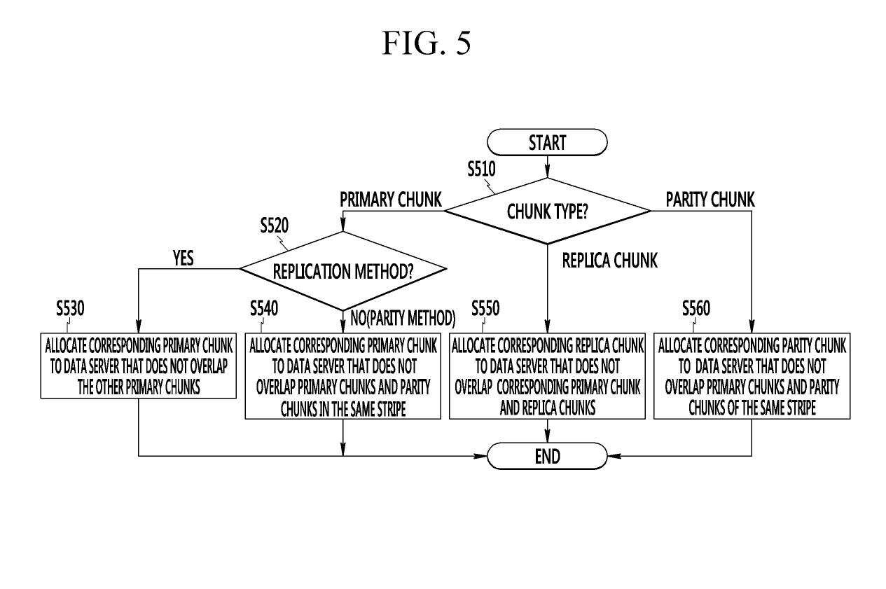

FIG. 5 is a view schematically illustrating a method of a metadata server allocating chunks of a file according to an exemplary embodiment of the present invention.

Referring to FIG. 5, in chunks of a file, three types of chunks, that is, primary chunks, replica chunks, and parity chunks generated by encoding the primary chunks that form stripes are provided. The chunks are differently allocated in accordance with chunk types.

The metadata server 200 first examines a type of a chunk to be allocated (S510).

When the type of the chunk to be allocated is a primary chunk, the metadata server 200 determines whether the chunk to be allocated is stored in the replication method or the parity method (S520). When the chunk to be allocated is a primary chunk stored in the replication method, the metadata server 200 allocates the corresponding chunk to a data server that does not maximally overlap a data server to which the other primary chunks that form a file are allocated (S530).

On the other hand, when the chunk to be allocated is a primary chunk stored in the parity method, the metadata server 200 allocates the corresponding chunk to a data server that does not overlap data servers in which the other primary chunks and parity chunks that belong to the same stripe are stored (S540).

When the chunk to be allocated is a replica chunk of a primary chunk, the metadata server 200 allocates the corresponding replica chunk to a data server that does not overlap a data server in which a primary chunk and another replica chunk are stored (S550).

When the chunk to be allocated is a parity chunk, the metadata server 200 allocates the corresponding chunk to a data server that does not overlap a data server in which primary chunks and parity chunks that belong to the same stripe are stored (S560).

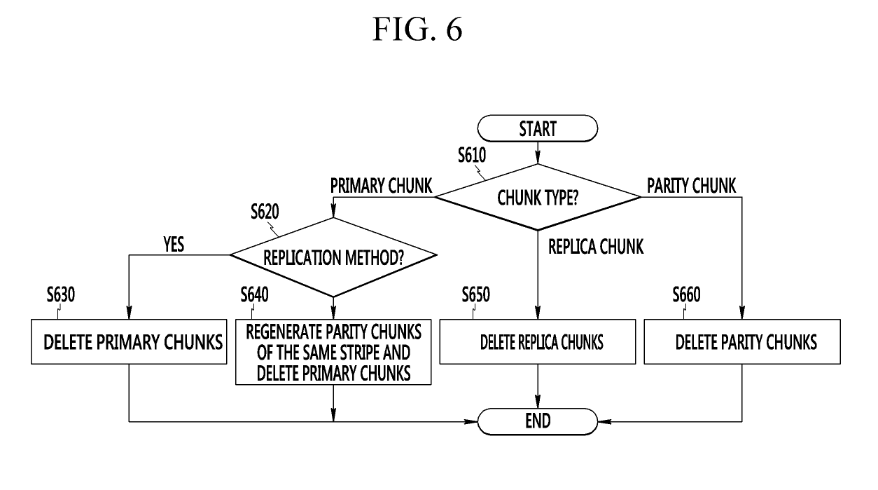

FIG. 6 is a view schematically illustrating a method of a metadata server deleting chunks of a file according to an exemplary embodiment of the present invention.

Referring to FIG. 6, deletion of chunks of a file varies with types of chunks to be deleted.

The metadata server 200 first examines a type of a chunk to be deleted (S610).

In the case of a primary chunk, a replica chunk, or a parity chunk stored in the replication method, the metadata server 200 simply deletes a corresponding chunk.

To be specific, when a type of a chunk to be deleted is a replica chunk of a primary chunk, the metadata server 200 deletes a corresponding replica chunk (S650), and when a type of a chunk to be deleted is a parity chunk, the metadata server 200 deletes a corresponding parity chunk (S660).

In addition, when a type of a chunk to be deleted is a primary chunk, the metadata server 200 determines whether the chunk to be deleted is stored in the replication method or the parity method (S620).

In the case of a primary chunk where a chunk to be deleted is stored in the replication method, the metadata server 200 deletes the corresponding primary chunk (S630).

On the other hand, in the case of a primary chunk in which a chunk to be deleted is stored in the parity method, the metadata server 200 regenerates a parity chunk that belongs to the same stripe to allocate the regenerated parity chunk to the data server 300 and deletes the primary chunk (S640). Then, the data server 300 generates parity data using data on another chunk that belongs to the same stripe to store the generated parity data in the regenerated parity chunk. That is, in the case of a primary chunk stored in the parity method, a primary chunk that belongs to a stripe is deleted so that a parity chunk is regenerated.

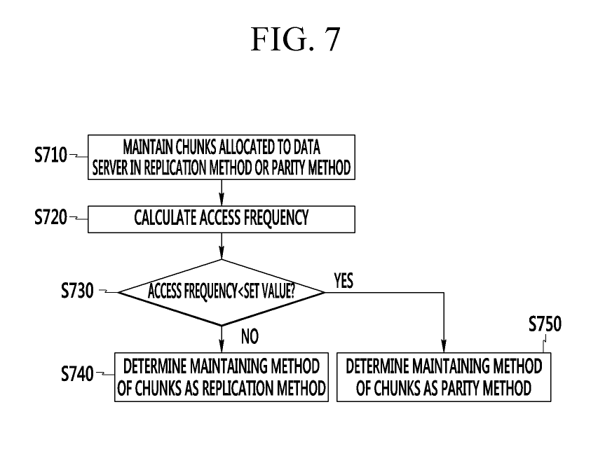

FIG. 7 is a view illustrating a method of a metadata server according to an exemplary embodiment of the present invention managing chunks allocated to a data server.

Referring to FIG. 7, chunks allocated to the data server 300 are maintained in the replication method or the parity method (S710).

The metadata server 200 calculates an access frequency of data of a file (S720).

The metadata server 200 makes a change from the replication method to the parity method and from the parity method to the replication method in accordance with the access frequency of the data of the file. To be specific, when the access frequency of the data of the file is no less than a predetermined value (S730), the metadata server 200 determines a method of the data server 300 maintaining chunks as the replication method (S740), and when the access frequency of the data of the file is less than the predetermined value, the metadata server 200 determines a method of the data server 300 maintaining chunks as the parity method (S740).

When the data server 300 maintains chunks in a different method from a determined method, the metadata server 200 requests the data server 300 to change the method of maintaining chunks to the determined method.

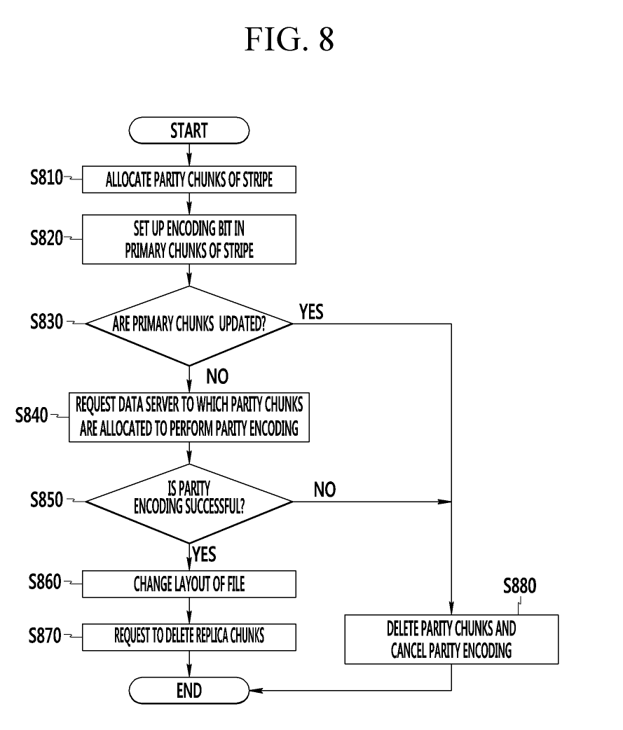

FIG. 8 is a flowchart illustrating an example of a method of a metadata server according to an exemplary embodiment of the present invention converting a file stored in a replication method into that stored in a parity method. That is, FIG. 8 is a flowchart illustrating processes of a distributed file system converting a stripe in the replication method to that in the parity method.

Referring to FIG. 8, the metadata server 200 generates parity chunks in a stripe and requests a data server to allocate the parity chunks (S810). The number of parity chunks to be allocated is determined by a parity width. At this time, the allocated parity chunks are set in a temporary chunk state. The metadata server 200 sets up an encoding bit representing that chunks are in a parity encoding state in primary chunks to be included in a stripe by a stripe width (S820).

When the primary chunks are updated (S830), the metadata server 200 deletes the parity chunks and cancels encoding (S880). The encoding state is set up in the primary chunks in order to cancel parity encoding, to delete the parity chunks, and to convert a next stripe when the primary chunks are updated while parity encoding is performed on the stripe.

When the encoding state is completely set up, the metadata server 200 requests the data server 300 to which the parity chunks are allocated to perform parity encoding (S840). Then, the data server 300 reads the primary chunks that belong to the stripe to generate parity data and to store the generated parity data in the parity chunks. Then, the data server 300 transmits a parity encoding result to the metadata server 200.

When parity encoding fails (S850), the metadata server 200 deletes the parity chunks and cancels encoding (S880).

On the other hand, when parity encoding is successful (850), the metadata server 200 changes a layout of a file so that the primary chunks in the replication method are changed to those in the parity method and the parity chunks in a temporary chunk state are changed to actual parity chunks (S860).

When the layout of the file is changed, the metadata server 200 requests the data server 300 to delete replica chunks of the primary chunks (S870).

Deletion of the replica chunks performed by the data server 300 is delayed. That is, the data server 300 does not immediately delete the replica chunks, but marks the replica chunks to be deleted to periodically delete the marked replica chunks or when a load of a system is small so as to not affect the load of the system. Such conversion processes are repeatedly performed on each stripe. At this time, when at least one stripe is converted, a stripe width and a parity width that are basic information items on a layout of a file are changed. Therefore, the metadata server 200 may convert an entire file or a part of a file. When a part of the file is converted, only the part may be reconverted. Such conversion processing may be determined by a manager in accordance with the access frequency of the file.

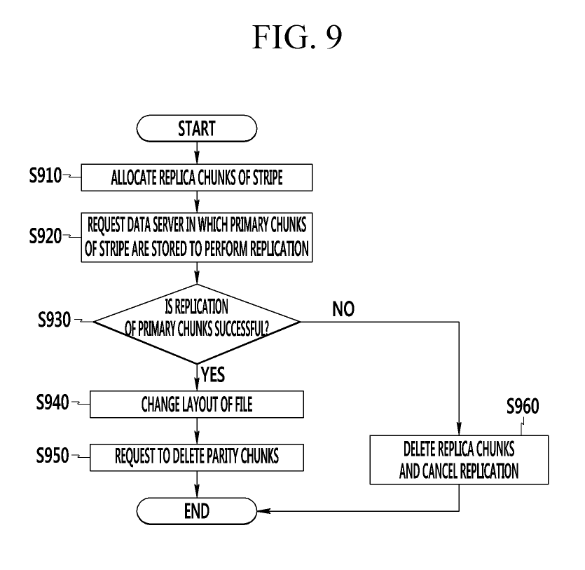

FIG. 9 is a flowchart illustrating an example of a method of a metadata server according to an exemplary embodiment of the present invention converting a file stored in a parity method into that stored in a replication method. That is, FIG. 9 is a flowchart illustrating processes of a distributed file system converting a stripe in the parity method into that in the replication method.

Referring to FIG. 9, in order to convert chunks of a file maintained in the parity method into those of a file maintained in the replication method, the metadata server 200 first requests the data server 300 to allocate replica chunks of primary chunks in a stripe (S910). At this time, the replica chunks are set in a temporary chunk state.

Next, the metadata server 200 requests the data server 300 in which each primary chunk is stored to allocate the replica chunks (S920). Then, the data server 300 reads primary chunks that belong to a stripe to replicate the primary chunks to the replica chunks. The data server 300 transmits a replication result to the metadata server 200.

When the data server 300 in which the primary chunks are stored malfunctions while the primary chunks are copied, the metadata server 200 recovers the primary chunks using parity chunks and the other primary chunks in the stripe.

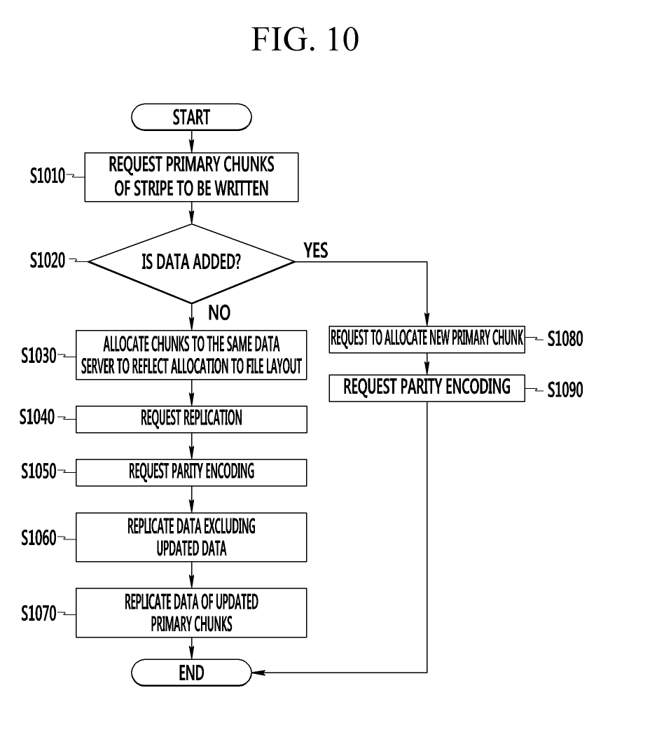

When the primary chunks are updated while the primary chunks are copied, the metadata server 200 may perform processes illustrated in FIG. 10.

When replication of the primary chunks fails (S930), the metadata server 200 deletes replica chunks and cancels replicating (S960).

On the other hand, when replication of the primary chunks is successful (S930), the stripe is formed of the replica chunks and the metadata server 200 changes a layout of a file so that the primary chunks in the parity method are changed to those in the replication method and the replica chunks in a temporary chunk state are changed to actual replica chunks (S940).

The metadata server 200 requests the data server 300 to delete the parity chunks in the stripe (S950). Deletion of the parity chunks performed by the data server 300 may be delayed.

When all of the stripes are completely copied, a stripe width and a parity width that are basic information items on a layout of a file are changed. Such stripe conversion processes are repeatedly performed on all of the stripes. When all of the stripes are not converted, the stripe width and the parity width are not changed. When the metadata server 200 malfunctions while stripe conversion is performed, temporary chunks that are allocated but are not completely copied may exist. The chunks are classified as trash chunks to be deleted when the system is recovered.

Such stripe conversion may be designated to be performed only on a specific chunk in accordance with the access frequency of a file.

On the other hand, when a file stored in the parity method is updated, the metadata server 200 must simultaneously update primary chunks and parity chunks. In the case where updated data is reflected only to one of the primary chunks and the parity chunks, when the other primary chunks or the other parity chunks that form the corresponding stripe are lost, the chunks that are not accessible may not be recovered. On the other hand, that a file is updated means that the access frequency of the file is increased. Therefore, in order to increase access efficiency of data, to reduce expenses for update, and to maintain availability in spite of a failure, the metadata server 200 changes a file maintaining method of the data server 300 to the replication method again.

FIG. 10 is a flowchart illustrating another example of a method of a metadata server according to an exemplary embodiment of the present invention converting a file stored in a parity method into that stored in a replication method. That is, FIG. 10 is a flowchart illustrating processes of a distributed file system converting a file stored in the parity method into that stored in the replication method when the file stored in the parity method is updated.

Referring to FIG. 10, when data of the file maintained in the parity method is updated, the client 100 requests primary chunks that belong to a stripe to be written (S1010).

When the client 100 requests the primary chunks that belong to the stripe to be written (S1010), the metadata server 200 determines whether the request is to add new data or to update previous data (S1020).

When the new data is added, the metadata server 200 requests the data server 300 to allocate a new primary chunk (S1080). Then, the data server 300 adds the new data to the primary chunk.

Next, the metadata server 200 requests the data server 300 to perform parity encoding (S1090). The data server 300 performs parity encoding using the added primary chunk to update parity chunks.

When previous data is to be updated, the metadata server 200 requests the data server 300 in which updated primary chunks are stored to allocate replica chunks and reflects the request to a layout of a file (S1030).

When the replica chunks are allocated, the metadata server 200 requests the data server 300 to perform replication (S1040). The data server 300 copies updated data of the primary chunks to the replica chunks.

In addition, the metadata server 200 requests the data server 300 to perform parity encoding (S1050).

The data server 300 performs parity encoding using only the updated data of the primary chunks to replicate data excluding the updated data of the primary chunks (S1060). By doing so, when a malfunction is generated while performing conversion into the parity method, the conventional parity method may be maintained. Such processes are repeatedly performed on the primary chunks that belong to the stripe.

The data server 300 copies the updated data of the primary chunks to the replica chunks (S1070). When all of the primary chunks that belong to the stripe are completely copied, a layout of a file is changed.

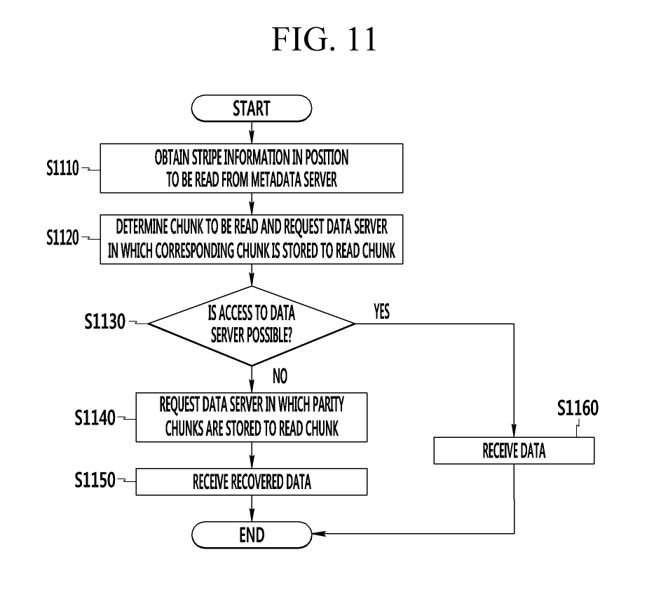

FIG. 11 is a flowchart illustrating processes when a data server has malfunctioned in a client according to an exemplary embodiment of the present invention. In FIG. 11, when primary chunks of a file maintained in the parity method are to be read, it is assumed that the data server in which the primary chunks are stored has malfunctioned.

Referring to FIG. 11, in order for the client 100 to read data when the data server 300 maintains the chunks of the file in the parity method, the client 100 first receives stripe information in a position to be read from the metadata server 200 (S1110).

The client 100 then determines a chunk to be read and requests the data server 300 in which the chunk is stored to read data (S1120). At this time, when the client 100 may access the data server 300 (S1130), the corresponding data is received from the data server 300 (S1160).

On the other hand, when the data server 300 has malfunctioned so that the client 100 may not access the data server 300 (S1130), the client 100 requests the data server 300 in which parity chunks in a stripe are stored to read data (S1140). Then, the data server 300 in which the parity chunks are stored reads the other primary chunks excluding a primary chunk that is not accessible to recover data.

The client 100 receives the recovered data from the data server 300 (S1160).

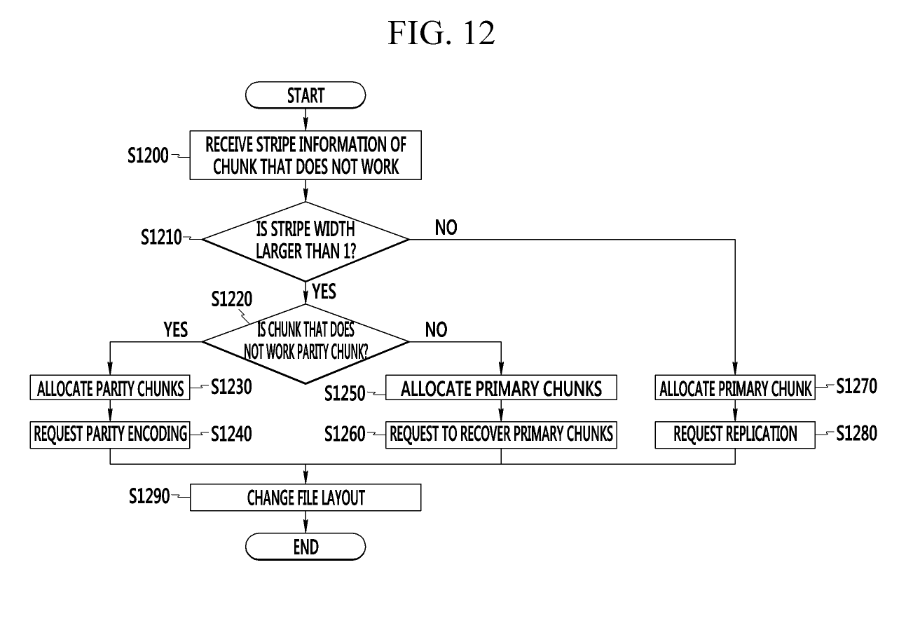

FIG. 12 is a flowchart illustrating a method of a data server according to an exemplary embodiment of the present invention recovering data.

Referring to FIG. 12, when the data server 300 has malfunctioned, a file of which chunks are stored in the data server 300 that has malfunctioned is recovered.

Recovering processes will be described as follows. First, the metadata server 200 reads stripe information on the file of which chunks are stored in the data server 300 that has malfunctioned (S1200). At this time, the metadata server 200 determines whether a stripe width is larger than 1 (S1210). That is, the metadata server 200 determines whether the chunks of the corresponding stripe are stored in the replication method or the parity method.

When the stripe width is not larger than 1, since it represents the replication method, the metadata server 200 allocates replica chunks to the data server 300 (S1270) to request the data server 300 to perform replication (S1280). Then, the data server 300 copies the allocated replica chunks using copies of the other replica chunks of a primary chunk that is inaccessible.

When the replica chunks are completely copied, the metadata server 200 changes a layout of a file (S1290).

When the stripe width is larger than 1, since it represents the parity method, the metadata server 200 determines whether a chunk that is inaccessible is a parity chunk (S1220).

When the parity chunk is inaccessible, the metadata server 200 allocates the parity chunk to the data server 300 (S1230) and requests the data server 300 to perform parity encoding (S1240). Then, the data server 300 reads primary chunks in the stripe to perform parity encoding, to generate parity data, and to store the generated parity data in the allocated parity chunk.

On the other hand, when a primary chunk rather than a parity chunk is inaccessible, the metadata server 200 allocates the primary chunk to the data server 300 (S1250) and requests the data server 300 to recover the primary chunk (S1260). Then, the data server 300 reads the other primary chunks and parity chunks in the stripe to recover the allocated primary chunk.

When the chunk that was inaccessible is completely recovered, the metadata server 200 changes a layout of a file (S1290).

The recovery may be automatically or manually performed.

According to the exemplary embodiment of the present invention, a distributed file system divides file-based data into chunks of a predetermined size to be distributed and stored in data servers, maintains the chunks in a replication method or a parity method, and changes a maintaining method from a replication method to a parity method and from a parity method to a replication method in accordance with an access frequency of a file. In particular, when an access frequency of data is large, chunks are maintained in the replication method so that it is possible to efficiently access data, and when the access frequency of the data is reduced, a maintaining method of the data is changed to the parity method again so that it is possible to efficiently use a storage space wasted in the replication method and to provide the same availability as that of the replication method.

In addition, data of a file may be maintained in a mixed method of the replication method and the parity method so that it is possible to efficiently access the data, to efficiently maintain the storage space, and to provide the same level of recoverability even when the data server has malfunctioned.

The exemplary embodiment of the present invention is not realized only by the above-described apparatus and/or method, but may also be realized by a program that realizes a function corresponding to the structure of the exemplary embodiment of the present invention or a recording medium in which the program is recorded. Such realization may be easily performed by those skilled in the art through the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of a metadata server of a distributed file system distributing and storing data of a file, comprising:
calculating an access frequency of the file; and
changing a maintaining method of chunks of a data server for dividing data of the file into chunk units to store the chunks in a stripe in accordance with the access frequency of the file.

2. The method of claim 1, wherein the changing a maintaining method of chunks comprises:
determining the maintaining method as a replication method when the access frequency of the file is no less than a predetermined value; and
determining the maintaining method as a parity method when the access frequency of the file is less than a predetermined value.

3. The method of claim 2, wherein determining the maintaining method as a replication method comprises:
allocating replica chunks of primary chunks of the file to a first data server of a plurality of data servers; and
requesting the first data server to replicate the replica chunks.

4. The method of claim 3, wherein determining the maintaining method as the replication method further comprises changing a layout of the file when the replication is completed.

5. The method of claim 3, wherein determining the maintaining method as the replication method further comprises the first data server converting a stripe having primary chunks and parity chunks in a parity method into a stripe having primary chunks and replica chunks in the replication method.

6. The method of claim 3, wherein allocating replica chunks of primary chunks of the file to the first data server comprises selecting a different data server from a data server in which the other replica chunks of the primary chunks are stored in the plurality of data servers as the first data server.

7. The method of claim 2, wherein determining the maintaining method as the parity method comprises:
allocating parity chunks in a stripe to the first data server of a plurality of data servers; and
requesting the first data server to perform parity encoding on the stripe.

8. The method of claim 7, wherein determining the maintaining method as the parity method further comprises changing a layout of the file when the parity encoding is successfully completed.

9. The method of claim 7, wherein determining the maintaining method as the parity method further comprises the first data server converting a stripe having primary chunks and replica chunks into a stripe having primary chunks and parity chunks.

10. The method of claim 7, wherein allocating parity chunks in a stripe to the first data server comprises selecting a different data server from a data server in which primary chunks and parity chunks that belong to the same stripe are stored in the plurality of data servers as the first data server.

11. The method of claim 2, further comprising allocating the chunk to the data server in accordance with a type of the chunk.

12. The method of claim 11, wherein allocating parity chunks in a stripe to the first data server comprises:
allocating the chunk to a different data server from a data server to which other primary chunks that form the file are allocated in a plurality of data servers when a type of the chunk is a primary chunk stored in a replication method; and
allocating the chunk to a different data server from a data server in which the other primary chunks and parity chunks that belong to the same stripe are stored in the plurality of data servers when a type of the chunk is a primary chunk stored in the parity method.

13. The method of claim 2, further comprising deleting chunks stored in the data server in accordance with a type of the chunk.

14. The method of claim 13, wherein deleting chunks stored in the data server comprises:
when a chunk to be deleted is a primary chunk, a replica chunk, or a parity chunk stored in a replication method, deleting the corresponding chunk; and
when a chunk to be deleted is a primary chunk stored in a parity method, generating parity chunks to allocate the generated parity chunks to the same stripe and deleting the corresponding chunk.

15. The method of claim 2, wherein changing a maintaining method of chunks further comprises determining the maintaining method as a replication method when data of a file stored in the parity method is updated.

16. The method of claim 2, further comprising allocating chunks of a data server that has malfunctioned to the first data server of a plurality of data servers to request the first data server to recover the allocated chunks.

17. A method of a data server of a distributed file system distributing and storing data of a file, comprising:
dividing data of the file into chunk units to store the chunks in a stripe;
receiving a request to change a method of maintaining chunks of the file from a metadata server; and
changing a method of maintaining chunks of the file,
wherein the metadata server determines whether to change a method of maintaining chunks of the file in accordance with an access frequency of the file.

18. The method of claim 17, wherein changing a method of maintaining chunks of the file comprises:
changing the method to a replication method when an access frequency of the file is no less than a predetermined value; and
changing the method into a parity method when an access frequency of the file is less than the predetermined value.

19. The method of claim 18, wherein changing a method of maintaining chunks of the file further comprises changing the method to a replication method when data of a file stored in the parity method is updated.

20. The method of claim 17, further comprising:
when a primary chunk in a replication method is inaccessible, replicating replications of the other replica chunks of the primary chunk that is inaccessible to replica chunks allocated by the metadata server;
when a parity chunk is inaccessible, reading primary chunks of the corresponding stripe using parity chunks allocated by the metadata server to recover the read primary chunks; and
when a primary chunk in a parity method is inaccessible, reading the other primary chunks and parity chunks of the corresponding stripe using primary chunks allocated by the metadata server to recover the inaccessible primary chunk.
